(19) United States
(12) Patent Application Publication
(10) Pub. No.: US 2014/0130773 A1
(43) Pub. Date: May 15, 2014

(54) MECHANICAL MOTION AMPLIFICATION FOR NEW THERMODYNAMIC CYCLES

(71) Applicant: McAlister Technologies, LLC, (US)

(72) Inventor: Roy Edward McAlister, Phoenix, AZ (US)

(21) Appl. No.: 13/843,197

(22) Filed: Mar. 15, 2013

Related U.S. Application Data
(60) Provisional application No. 61/725,448, filed on Nov. 12, 2012.

(51) Int. Cl. F02B 17/00

(52) U.S. Cl. CPC F02B 17/005
USPC 123/305; 123/478

(57) ABSTRACT

The present technology relates generally to mechanical motion amplification for fuel injectors. In some embodiments, an injector for introducing gaseous or liquid fuel into a combustion chamber includes an injector body having a base portion configured to receive fuel into the body and a valve coupled to the body. The valve can be movable to an open position to introduce fuel into the combustion chamber. The injector further includes a valve operator assembly. The valve operator assembly can include a valve actuator coupled to the valve and movable between a first position and a second position, and a prime mover configured to generate an initial motion. The valve operator assembly can also include a mechanical stroke modifier configured to alter at least one of a direction or magnitude of the initial motion and convey the altered motion to the valve actuator.

### CROSS-REFERENCE TO RELATED APPLICATION(S)

The present application claims priority to and the benefit of U.S. Provisional Patent Application No. 61/725,448, filed Nov. 12, 2012, which is incorporated herein by reference in its entirety.

### TECHNICAL FIELD

The present technology relates generally to mechanical motion amplification for new thermodynamic cycles, and associated systems and methods. Specific embodiments are directed to mechanical motion amplifiers for use in fuel injection systems.

### BACKGROUND

Fuel injection systems are typically used to inject a fuel spray into an inlet manifold or a combustion chamber of an engine. Fuel injection systems have become the primary fuel delivery system used in automotive engines, having almost completely replaced carburetors since the late 1980s. Fuel injectors used in these fuel injection systems are generally capable of two basic functions. First, they deliver a metered amount of fuel for each inlet stroke of the engine so that a suitable air-fuel ratio can be maintained for the fuel combustion. Second, they disperse the fuel to improve the efficiency of the combustion process. Conventional fuel injection systems are typically connected to a pressurized fuel supply, and the fuel can be metered into the combustion chamber by varying the time for which the injectors are open. The fuel can also be dispersed into the combustion chamber by forcing the fuel through a small orifice in the injectors.

### BRIEF DESCRIPTION OF THE DRAWINGS

FIG. 1 is a schematic cross-sectional side view of an injector configured in accordance with an embodiment of the technology.

FIG. 2 is a partially schematic side view of a mechanical stroke modifier configured in accordance with embodiments of the technology.

FIG. 3A is a top view of a mechanical stroke modifier configured in accordance with embodiments of the technology.

FIG. 3B is a side, partially-cutaway view of the mechanical stroke modifier of FIG. 3A.

FIG. 4A is a side view of a mechanical stroke modifier configured in accordance with embodiments of the technology.

FIG. 4B is an end view of the mechanical stroke modifier of FIG. 4A.

FIG. 5A is a side view of a mechanical stroke modifier configured in accordance with embodiments of the technology.

FIG. 5B is a partially schematic side view of the mechanical stroke modifier of FIG. 5A showing pitch diameters and unidirectional motions in accordance with embodiments of the technology.

FIG. 5C is a top view of the mechanical stroke modifier of FIG. 5B.

FIG. 6A is a side view of a mechanical stroke modifier configured in accordance with embodiments of the technology.

FIG. 6B is a top view of the mechanical stroke modifier of FIG. 6A.

FIG. 6C is an illustration of vectors representing the direction and magnitude of motion within the mechanical stroke modifier of FIG. 6A.

FIG. 7A is a cross-sectional side view of a fuel injector assembly configured in accordance with embodiments of the technology.

FIGS. 7B and 7C are magnified views of portions of the fuel injector assembly of FIG. 7A configured in accordance with embodiments of the technology.

FIG. 7D is an end view of the fuel injector assembly of FIG. 7A.

FIG. 8 is a cross-sectional side view of a combined fuel-injection and ignition system configured in accordance with embodiments of the technology.

### DETAILED DESCRIPTION

The present technology relates generally to mechanical motion amplification for fuel injectors. In some embodiments, an injector for introducing gaseous or liquid fuel into a combustion chamber includes an injector body having a base portion configured to receive fuel into the body and a valve coupled to the body. The valve can be movable to an open position to introduce fuel into the combustion chamber. The injector further includes a valve operator assembly. The valve operator assembly can include a valve actuator coupled to the valve and movable between a first position and a second position, and a prime mover configured to generate an initial motion. The valve operator assembly can also include a mechanical stroke modifier configured to alter at least one of a direction or magnitude of the initial motion and convey the altered motion to the valve actuator.

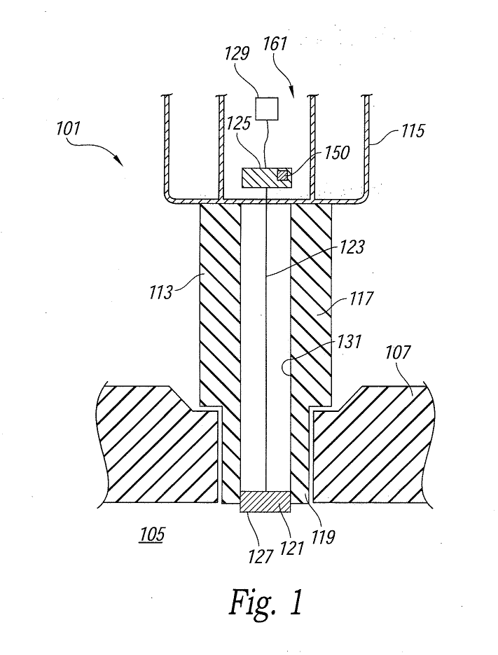

Specific details of several embodiments of the technology are described below with reference to FIGS. 1-8. Other details describing well-known structures and systems often associated with amplifiers, fuel injection systems, and ignition systems have not been set forth in the following disclosure to avoid unnecessarily obscuring the description of the various embodiments of the technology. Many of the details, dimensions, angles, and other features shown in the Figures are merely illustrative of particular embodiments of the technology. Accordingly, other embodiments can have other details, dimensions, angles, and features without departing from the spirit or scope of the present technology. A person of ordinary skill in the art, therefore, will accordingly understand that the technology may have other embodiments with additional elements, or the technology may have other embodiments without several of the features shown and described below with reference to FIGS. 1-8.

FIG. 1 is a schematic cross-sectional side view of an injector 101 configured in accordance with an embodiment of the technology. The injector 101 is configured to inject fuel into a combustion chamber 105 and utilize a mechanical stroke modifier 150 to transfer curvilinear or linear motion within the injector 101. For example, the mechanical stroke modifier 150 can transfer motion in order to provide an increased, decreased, or otherwise altered stroke of movement from a prime mover, such as a piezoelectric, magnetostrictive, electromagnetic, electromechanical, pneumatic, or hydraulic valve driver. The mechanical stroke modifier 150 is schematically illustrated in FIG. 1 and can be positioned at any location on the injector 101 and coupled to any of the features described in detail below. Moreover, in certain embodiments, the mechanical stroke modifier 150 can be integral with one or more of the valve actuating components described in detail below. Furthermore, although several of the additional features of the illustrated injector 101 described below are shown schematically for purposes of illustration, several of these schematically illustrated features are described in detail below with reference to various features of embodiments of the disclosure. Accordingly, the relative location, position, size, orientation, etc. of the schematically illustrated components of the Figures are not intended to limit the present disclosure.

In the illustrated embodiment, the injector 101 includes a casing or body 113 having a middle portion 117 extending between a base portion 115 and a nozzle portion 119. The nozzle portion 119 extends at least partially through a port in an engine head 107 to position the nozzle portion 119 at the interface with the combustion chamber 105. The injector 101 further includes a fuel passage or channel 131 extending through the body 113 from the base portion 115 to the nozzle portion 119. The channel 131 is configured to allow fuel to flow through the body 113. The channel 131 is also configured to allow other components, such as a valve operator assembly 161, an actuator 123, instrumentation components, and/or energy source components of the injector 101 to pass through the body 113. According to additional features of the illustrated embodiment, the nozzle portion 119 can include one or more ignition features for generating an ignition event for igniting the fuel in the combustion chamber 105. For example, the injector 101 can include any of the ignition features disclosed in U.S. patent application Ser. No. 12/841,170 entitled “INTEGRATED FUEL INJECTORS AND IGNITERS AND ASSOCIATED METHODS OF USE AND MANUFACTURE,” filed Jul. 21, 2010, which is incorporated herein by reference in its entirety.

In certain embodiments, the actuator 123 can be a cable, stiffened cable, or rod that has a first end portion that is operatively coupled to a flow control device or valve 121 carried by the nozzle portion 119. The actuator 123 can be integral with the valve 121 or a separate component from the valve 121. As such, the valve 121 is positioned proximate to the interface with the combustion chamber 105. Although not shown in FIG. 1, in certain embodiments the injector 101 can include more than one flow valve, as well as one or more check valves positioned proximate to the combustion chamber 105 and/or at other locations on the body 113. For example, the injector 101 can include any of the valves and associated valve actuation assemblies as disclosed in the patent applications incorporated by reference herein.

The position of the valve 121 can be controlled by the valve operator assembly 161. For example, the valve operator assembly 161 can include a plunger or driver 125 that is operatively coupled to the actuator 123. The actuator 123 and/or driver 125 can further be coupled to a processor or controller 129. As explained in detail below with reference to various embodiments of the disclosure, the driver 125 and/or actuator 123 can be responsive to the controller 129. The controller 129 can be positioned on the injector 101 or remotely from the injector 101. The controller 129 and/or the driver 125 are configured to rapidly and precisely actuate the actuator 123 to inject fuel into the combustion chamber 105 by moving the valve 121 via the actuator 123. For example, in certain embodiments, the valve 121 can move outwardly (e.g., toward the combustion chamber 105), and in other embodiments the valve 121 can move inwardly (e.g., away from the combustion chamber 105) to meter and control injection of the fuel. Moreover, the driver 125 can tension the actuator 123 to retain the valve 121 in a closed or seated position, and the driver 125 can relax or relieve the tension in the actuator 123 to allow the valve 121 to inject fuel, and vice versa. In other embodiments, the valve 121 may be opened and closed depending on the pressure of the fuel in the body 113, without the use of an actuator cable or rod. Additionally, although only a single valve 121 is shown at the interface of the combustion chamber 105, in other embodiments the valve 121 can be positioned at other locations on the injector 101 and can be actuated in combination with one or more other flow valves or check valves.

The injector 101 can further include a sensor and/or transmitting component 127 for detecting and relaying combustion chamber properties, such as temperatures and pressure, and providing feedback to the controller 129. The sensor 127 can be integral to the valve 121, the actuator 123, and/or the nozzle portion 119 or a separate component that is carried by any of these portions of the injector 101. In one embodiment, the actuator 123 can be formed from fiber optic cables or insulated transducers integrated within a rod or cable, or it can include other sensors to detect and communicate combustion chamber data. Although not shown in FIG. 1, in other embodiments, the injector 101 can include other sensors or monitoring instrumentation located at various positions on the injector 101. For example, the body 113 can include optical fibers integrated into the material of the body 113. In addition, the valve 121 can be configured to sense or carry sensors to transmit combustion data to one or more controllers 129 associated with the injector 101. This data can be transmitted via wireless, wired, optical, or other transmission mediums to the controller 129 or other components. Such feedback enables extremely rapid and adaptive adjustments for desired fuel injection factors and characteristics including, for example, fuel delivery pressure, fuel injection initiation timing, fuel injection durations, combustion chamber pressure and/or temperature, the timing of one, multiple or continuous plasma ignitions or capacitive discharges, etc. For example, the sensor 127 can provide feedback to the controller 129 as to whether the measurable conditions within the combustion chamber 105, such as temperature or pressure, fall within ranges that have been predetermined to provide desired combustion efficiency. Based on this feedback, the controller 129 in turn can direct the mechanical stroke modifier 150 to manipulate the frequency and/or degree of valve 121 actuation.

The mechanical stroke modifier 150 can take on numerous forms according to different embodiments of the disclosure, and can transfer or modify the direction and/or magnitude of motion of the driver 125, the actuator 123, the valve 121, and/or other components of the fuel injector 101. The motion transfer applied to any of these components can result in an increased, decreased, or otherwise altered stroke of valve actuation and associated altered conditions in the combustion chamber 105. In one embodiment, the mechanical stroke modifier 150 can be configured to achieve the desired quantity or pattern of the injected fuel bursts by transferring motion in the driver 125 to alter the degree to which the valve 121 is opened.

In another embodiment, the mechanical stroke modifier 150 transfers motion directly to the actuator 123 by any of the means described above. The actuator 123 in turn opens the valve 121 in a stroke responsive to the motion transfer, thereby altering the fuel distribution quantity and/or pattern. In some embodiments, the mechanical stroke modifier 150 transfers motion to the valve 121 directly.

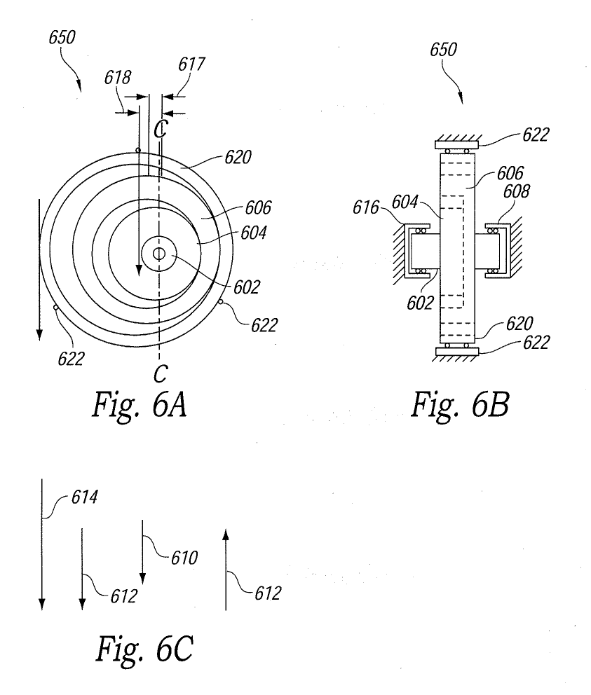

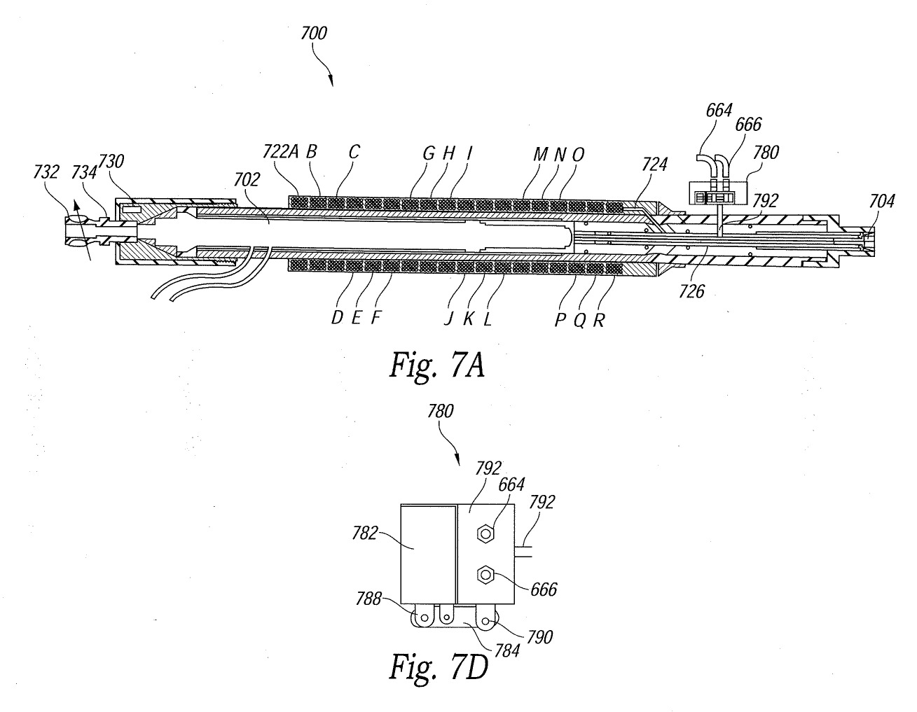

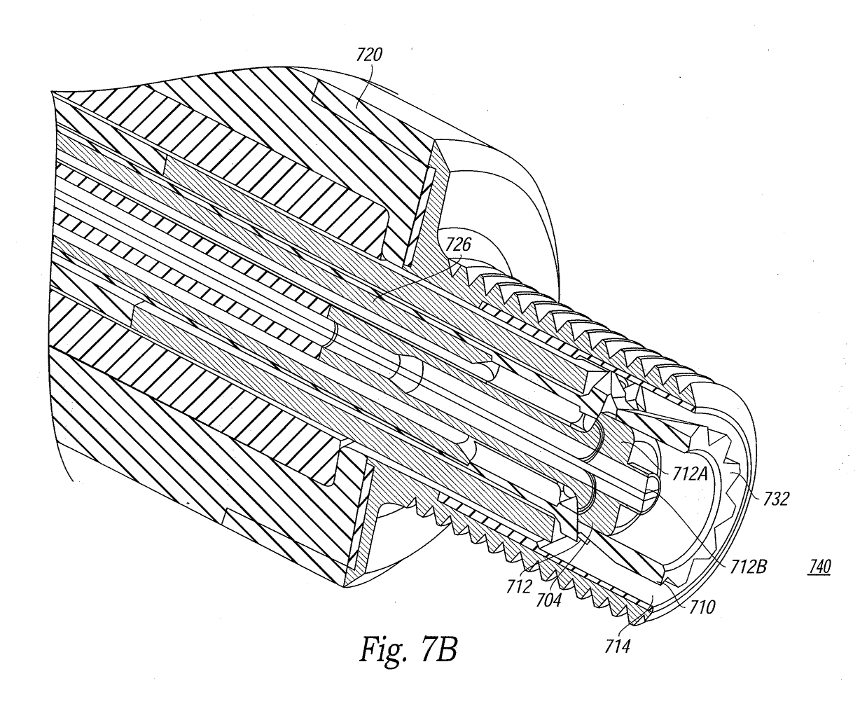

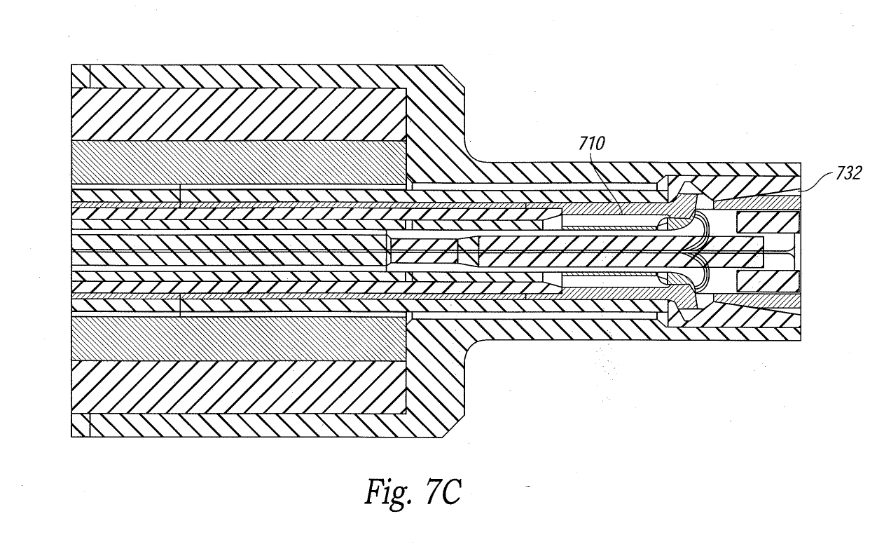

In another embodiment, that will be described in further detail with reference to FIGS. 6 and 7, the mechanical stroke modifier 150 may be utilized to provide electrical and/or thermal barrier functions to the injector 101. In some embodiments, the mechanical stroke modifier 150 enables a prime mover that produces initial motion (e.g., the driver 125) to operate at a much lower temperature than a driven member that moves a greater distance (e.g., the valve 121). An application of this thermal barrier function is a system for dissociation of a hydrogen donor, such as a hydrocarbon.

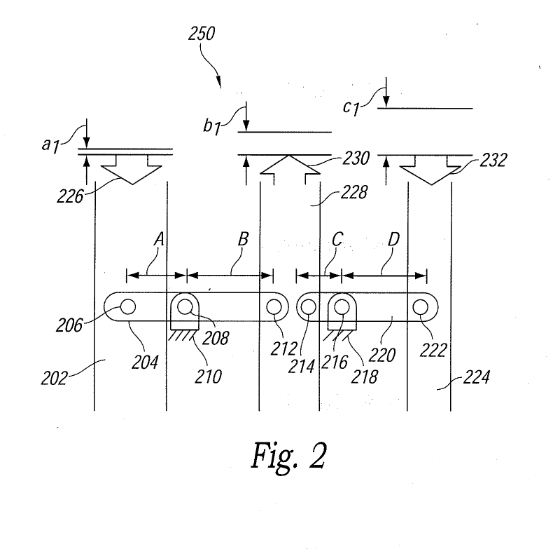

The features of the injector 101 described above with reference to FIG. 1 can be included in any of the embodiments described below with reference to FIGS. 2-7 or in other embodiments of fuel injectors described in publications that have been incorporated by reference herein.

FIG. 2 is a partially schematic illustration of a mechanical stroke modifier 250 configured in accordance with embodiments of the technology. Some aspects of the mechanical stroke modifier 250 are shown transparently to better illustrate certain aspects of the technology. The mechanical stroke modifier 250 can transfer curvilinear or linear motion, such as motion having magnitude a₁, to a reduced, equal, or greater motion magnitude b₁. The motion magnitude b₁ may be further translated any number of times and is illustrated as translated to motion magnitude c₁. The motion transfer occurs by the action of one or more levers 204, 220. The mechanical stroke modifier 250 includes a first rod or strut 202 that is moved distance a₁ by initial force 226 and produces motion b₁ by force 230 transferred by a second strut 228. In the embodiment shown, the motion magnitude b₁ is greater than the motion magnitude a₁ and is a function of the lever 204 ratio of length B/A separated by fulcrum 210. The motion magnitude c₁ is created by force 232 imparted on a third strut 224 and is greater than motion magnitude b₁. The motion magnitude c₁ is a function of the lever 220 ratio of length D/C separated by fulcrum 218.

In some embodiments, the initial force 226 is created by a prime mover, such as a piezoelectric, magnetostrictive, electromagnetic, electromechanical, pneumatic, or hydraulic valve driver. Bearings 206, 208, and 212 can be selected to enable low friction lever-action to provide axial motion in the second strut 228 in the opposite direction of the first strut 202; similarly, bearings 214, 216, and 222 can provide for low friction lever-action to thrust the third strut 224 in the same direction as the first strut 202. Illustratively, overall amplification of motion at commensurately lower force may be developed by selections of the ratios B/A and D/C. Given the motion restraints (i.e. anti-friction bearings) and consequent freedoms allowed for the first and third struts 202, 224, the motion c₁ of the third strut 224 is produced in the same direction as the motion a₁ and may be less, the same, or greater than the motion of the second strut 228 depending upon the ratios B/A and D/C that are selected.

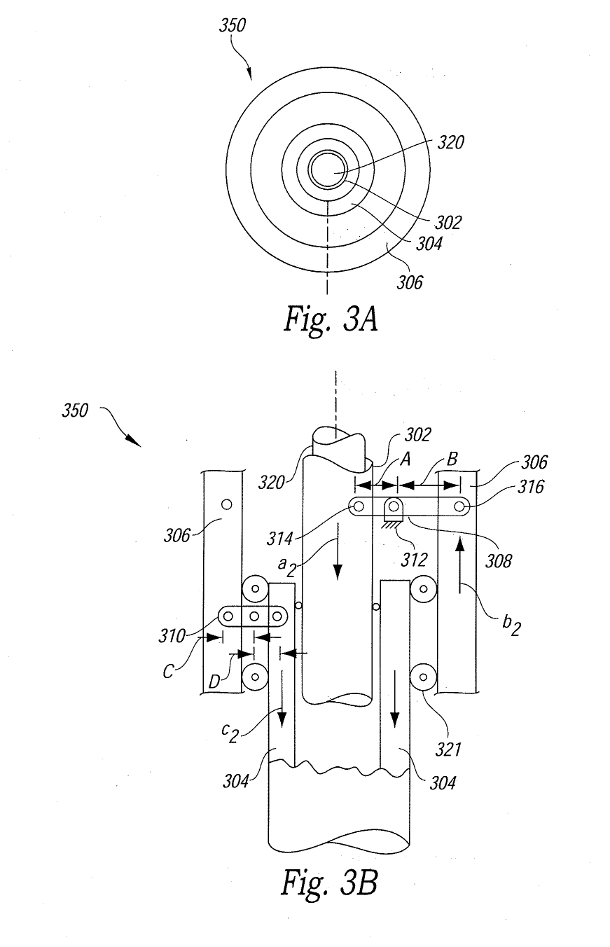

FIG. 3A is a top view of a mechanical stroke modifier 350 configured in accordance with embodiments of the technology. FIG. 3B is a side, partially cutaway view of the mechanical stroke modifier 350 of FIG. 3A. Referring to FIGS. 3A and 3B together, the mechanical stroke modifier 350 includes first and second levers 308, 310 coupled to first, second, and third telescoping and/or coaxial plungers or tubes 302, 304, and 306 for transmitting force and motion. The first lever 308 is coupled to first and third tubes 302 and 306 at bearings 314, 316 and pivots on a first fulcrum 312. The first lever 308 moves with displacement a₂ of the first tube 302, which translates to produce displacement b₂ in the third tube 306 according to the ratio of B/A. Similarly, the second lever 310 is coupled to the second and third tubes 304, 306 and displaces the second tube 304 by motion magnitude c₂ upon moving third tube 306 by motion magnitude a₂, according to the ratio D/C.

The mechanical stroke modifier 350 can be used to increase or decrease stroke. For example, in applications such as providing an increased stroke of piezoelectric, magnetostrictive, electromagnetic, electromechanical, pneumatic, or hydraulic valve operators in the fuel injector system described above with reference to FIG. 1, the motion magnitude a₁ translated with lever ratios B/A and D/C exceed unity to substantially increase the stroke. In other applications, such as manual or foot operated brakes or clutches, initial motion c₁ produces a relatively smaller motion a₁ at a substantially greater force.

In certain applications it can be advantageous to mount an appropriately anchored, connected, and/or preloaded prime mover such as a piezoelectric, magnetostrictive, electromagnetic, electromechanical, pneumatic, or hydraulic force generating device 320 largely or entirely within the first tube 302 to protect the prime mover 320 (and associated wiring and cables) and to provide an assembly with sufficient section modulus to prevent column deflection or buckling. The prime mover 320 can thus greatly improve the fatigue endurance of the mechanical stroke modifier 350.

Depending upon the sizes of assembly components and application characteristics, various friction reduction techniques or materials may be included. Various components of the mechanical stroke modifier 350 (e.g., levers or tubes), can be made of various materials such as lightweight ceramics, silicon nitride, and/or aluminum or titanium alloys. In some embodiments, these components can be anodized and/or coated with films such as aluminum-magnesium-boride AlMgB₁₄), diamond-like carbon, molybdenum sulfide, PTFE, or other selections. This enables particularly lightweight compact assemblies that provide electrical insulation with high stiffness and side-load capabilities along with very high linear amplification and extremely rapid push-pull and performance capabilities.

The mechanical stroke modifier 350 can include numerous variations to tailor the device to a particular application. For example, in certain applications with high ratios for motion amplification, captive nano, micro, or macro ball bearings 321 may be incorporated to reduce friction and/or to increase the diameter of the third tube 306 to further improve the section modulus and stiffness of an assembly of two or more lever tube struts. In further embodiments, it may be desirable to provide two, three, or more equally-spaced levers, such as the first lever 308, and to operate the bearings 314 and 316 within arced slots to minimize backlash and to balance reaction forces and side loads. Further, providing supports for the first fulcrum 312 can allow the mechanical stroke modifier 350 to be adaptable to a wide variety of applications including reversing the direction of thrust, increasing or decreasing the magnitude of motion, or increasing or decreasing the commensurate magnitude of force or thrust. In still further embodiments, one or more struts such as the first tube 302 may include a spring, magnet, or pneumatic cylinder to return the assembly to a starting position at the end of a force application cycle.

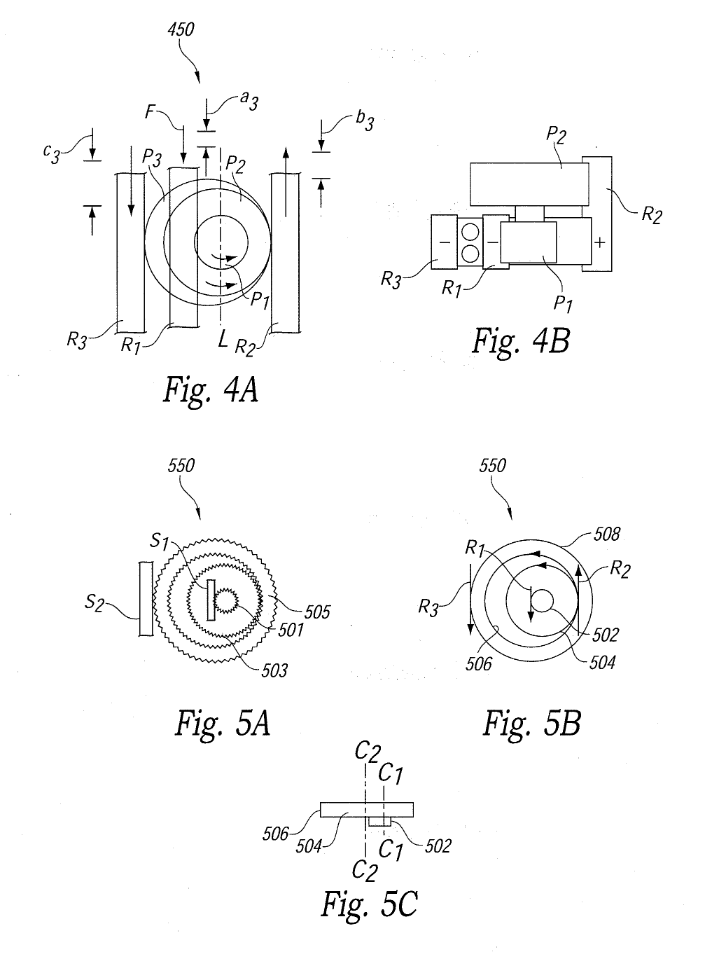

FIG. 4A is a side view of a mechanical stroke modifier 450 configured in accordance with embodiments of the technology. FIG. 4B is an end view of the mechanical stroke modifier 450 of FIG. 4A. Referring to FIGS. 4A and 4B together, the mechanical stroke modifier 450 includes gear racks R₁, R₂, and R₃ and pinions P₁, P₂, and P₃. The racks and pinions can be operably connected such that an initial force F can be applied to rack R₁ to cause pinion P₁ to rotate counterclockwise on shaft L and to cause larger diameter pinion P₂, which is coupled to the same shaft on line L, to rotate counterclockwise at the same angular velocity. In various embodiments, diameters of pinions P₁ and P₂ may be equal or unequal. Therefore the ratio of P₂/P₁ may be unity, less than unity, or over unity as shown.

Pinion P₃ operates adjacent, below, or beside pinion P₂ against rack R₂ to displace another suitably engaged rack R₃ in any vector of desired thrust, such as parallel to the vector of initial force F (as shown) or along another vector as determined by boundary restraints or bearings that guide the racks R₁, R₂, and R₃. Pinion P₃ may be equal, smaller than either pinion P₁ or P₂, or larger than P₂ as shown.

In some embodiments of operation, such as amplifying the motion of a piezoelectric, magnetostrictive, electromagnetic, electromechanical, pneumatic, or hydraulic valve operator that exerts force F to move rack R₁ through distance a₃, the mechanical stroke modifier 450 causes rack R₂ to move a larger distance b₃ which rotates pinion P₃ to move rack R₃ a much larger desired displacement c₃. Depending upon the desired geometrical characteristics of the transmission assembly, gear racks R₁, R₂, and R₃ may be parallel as shown or each may be operated on slides or other types of suitable live bearings at various other orientations.

In further embodiments of operation, the forces and distances or operations enabled by pinions P₁, P₂, and P₃ along with arrangements for racks R₁, R₂, and/or R₃ can be at different directions and magnitudes as needed to produce a desired actuation and/or thrust. For example, rack R₁ could be some angle such as perpendicular to R₂ and, similarly, R₃ could be operated to produce thrust at another angle as needed.

FIG. 5A is a side view of a mechanical stroke modifier 550 configured in accordance with embodiments of the technology. The mechanical stroke modifier 550 includes components for assured traction and prevention of slippage, such as a pinion 501, a gear 503, and a rim gear 505. The rim gear 505 has gear teeth on an inside circumference and an outside circumference. The gear teeth on the inside circumference of the rim gear 505 interface with gear teeth on the gear 503. Strut racks S₁ and S₂ can provide/transfer linear or curvilinear motions by meshing with the pinion 501 and the rim gear 505, respectively. In further embodiments, any number of additional strut racks can be positioned at various other suitable orientations and locations on the pinions and gears. In various embodiments, the struts S₁, S₂ are operated within boundaries such as rocker bearings to produce and/or accommodate curvilinear travel for application of initial force, for transmission of force, and/or for amplification or contraction of motion magnitude.

FIG. 5B is a partially schematic side view of the mechanical stroke modifier 550 of FIG. 5A showing pitch diameters 502, 504, and 506 and unidirectional motions R₁, R₂, and R₃ of the pinion 501, gear 503, and rim gear 505, respectively. The motions R₁, and R₃ show the motions of struts S₁, S₂, respectively. FIG. 5C is a top view of the mechanical stroke modifier 550 of FIG. 5B. In FIGS. 5B and 5C, the gear teeth and struts are omitted for purposes of clarity.

Referring to FIGS. 5A-5C together, the pinion 501 includes suitable gear teeth on the outside diameter 502 that mesh with teeth on strut S₁ that is thrust distance R₁ by a prime mover, such as a piezoelectric, magnetostrictive, electromagnetic, electromechanical, pneumatic, or hydraulic motor-generator (not shown). Therefore, in one embodiment, the pinion 501 provides torque to turn the larger integral or common shaft mounted gear 503 with an outside pitch diameter 504 to mesh with teeth on the inside diameter of the rim gear 505 with an inside pitch diameter 506 and outer pitch diameter 508.

In operation, the assembly of the pinion 501 and the gear 503, with pitch diameters 502 and 504, respectively, can rotate on centerline C₁, and the rim gear 505 rotates on centerline C₂, to provide amplification of linear motion R₁ to an increased linear strut motion R₂, which may further increase to linear strut motion R₃, depending upon the ratio of respective pitch diameters, including the outer pitch diameter 508 of gear teeth on the outside circumference of the rim gear 505 that meshes with strut S₂, operating through motion R₃, which is illustrated in FIG. 5B as a linear motion arrangement.

Depending upon the bearing mounts and geometrical arrangements for maintaining centerlines C₁ and C₂, and the bearings for their associated struts S₁ and S₂, respectively, directed motions R₁, R₂, and R₃ may be at any particular angle with respect to the initiating motion R₁ and/or may be or include curvilinear motions.

In various embodiments the mechanical stroke modifier 550 technology can be applicable to signal generation, feedback and control systems, valve operators, flow directors, and fuel pumps. Other embodiments combine pneumatic or hydraulic intensifiers, motion amplifiers, and/or direction altering relays including actions with struts such as S₁ and S₂. Struts, pinions, and/or gears may be micro, miniature, macro, and/or combinations of micro, miniature, and macro dimensioned components.

FIGS. 6A and 6B are side and top views, respectively, of a mechanical stroke modifier 650 configured in accordance with embodiments of the technology. The mechanical stroke modifier 650 can have several features generally similar to the geared embodiments described above. For example, the mechanical stroke modifier 650 can include a pinion 602, a gear 604, an inner rim wheel 606, and an outer rim wheel 620. In further embodiments, one or more of these features comprises a gear, rotor wheel, rim wheel, lever, or other similar structure.

FIG. 6C is an illustration of vectors representing the direction and magnitude of motion within the mechanical stroke modifier 650 of FIG. 6A. More specifically, the vectors include an initial motion 610 corresponding to movement of the pinion 602 and subsequently transferred and/or transformed motions 612, 614 corresponding to the movement of the inner rim wheel 606 and outer rim wheel 620, respectively. In further embodiments, the mechanical stroke modifier 650 can include or cause any number of other motions at selected angles from vector 610 along vectors that are tangential to the major diameter or pitch diameter of the wheels 606 or 620 for a larger amplification ratio.

Referring to FIGS. 6A-6C together, bearing assemblies 608, 616, and 622 can provide friction reduction and maintenance of parallel centerlines for rotations of the outer rim wheel 620, inner rim wheel 606, gear 604, and pinion 602. The inner rim wheel 606 is offset from the pinion 602 centerline C of rotation by distance 617. The outer rim wheel 620 is offset from the gear 602 centerline C of rotation by distance 618. This provides a low friction reduction or amplification of motions depending upon the choice of primary force application (i.e., the cause of motion 610 or 614) and the resulting response.

Illustratively, the inner rim wheel 606 can be a rim and web or spoke component with inside and/or outside gear teeth on pitch diameters shown or a segment of such a configuration to act as a limited rotation lever. Accordingly, the inner rim wheel 606 may be a gear or friction drive component that the gear 604 drives by engaged gear teeth or contact friction. The ratio of the pitch diameter of the gear 604 to the pinion 602 provides an initial motion amplification that may be further amplified by the ratio of the outer pitch diameter of the inner rim wheel 606 to the inner pitch diameter on the inner rim wheel 606 as shown. Additional amplification may be produced by one or more nested or superimposed rim gears of friction drive wheels or segments as depicted by the outer rim wheel 620. While this illustrates amplification by sets of superimposed rim gears or wheels, any number of other amplifications may be similarly achieved with pinion-gear diameter ratios and appropriate jack shaft transfers. Motions such as those denoted by vectors 610-614 may be expressed by suitable gear racks or by friction drive shafts. In many applications, such racks or shafts move in vectors that are maintained by additional bearings and supports including mutually supporting low friction bearing elements between parallel gear racks, friction drive shafts, or combinations of these features.

In an application for amplification of linear motion produced in response to a prime mover such as an electromagnetic solenoid, piezoelectric, magnetostrictive, electromagnetic, electromechanical, pneumatic, or hydraulic force generator, a relatively small initial motion 610 is amplified into successively larger motions such as vectors 612 and 614. Various spring selections (not shown) including clock, leaf, and helical coil types may be utilized to urge the assembly back to an initial position between applications of force by such prime movers.

The mechanical stroke modifier 650 can include features for minimizing or eliminating gear backlash. Such features can include friction drives and any of numerous gear engagement profiles and materials selected for such purpose. For example, the mechanical stroke modifier 650 can include spring-loaded split gears that assure constant pitch engagement. Thermal expansion/contraction of components such as prime movers and/or linkages may be compensated or minimized by appropriate selections of the coefficients of thermal expansion for material selections for selected components.

The mechanical stroke modifier 650 may also be utilized to provide electrical and/or thermal barrier functions to produce amplified motion in any suitable direction, including push or pull force along vectors (e.g., along vectors 610 or 614). In some embodiments, the mechanical stroke modifier 650 enables a prime mover that produces the initial motion 610 to operate at a much lower temperature than the driven member that moves a greater distance, such as motion 612 or 614. In an illustrative example, the prime mover producing initial motion 610 is a piezoelectric component that can provide push and/or pull force, as it is maintained within a much lower temperature range than a valve that controls fluids that may range in temperature from cryogenic to heated fluids (i.e. −421° F. to 2400° F.) as a result of motion 614 from the outer rim wheel 620.

An application of this thermal barrier function is a system for dissociation of a hydrogen donor, such as a hydrocarbon, as shown in Equation 1.

CxHy+HEAT→X Carbon+0.5YH₂ Equation 1

This application allows inexpensive, off-peak utility power and/or surplus renewable energy sources (including regenerative recovery of energy) to utilize fossil and/or fresh biomass to produce carbon for manufacturing durable goods and to produce liquid fuels such as cryogenic hydrogen or liquid hydrogen storage compounds (including alcohols such as methanol, ethanol, propanol, or butanol) by reaction with carbon dioxide from the atmosphere or more concentrated sources such as a bakeries, breweries, ethanol plants, or power plants using fossil coal, oil, or natural gas. Equations 2 and 3 summarize selected illustrative productions of methanol and ethanol for utilization as liquid hydrogen carriers. Cryogenic liquid hydrogen and/or such ambient temperature liquid hydrogen carriers subsequently receive heat rejected from a heat engine or fuel cell to form gases at high pressure for direct injection into fuel cells and/or combustion engines.

3H₂+CO₂→CH₃OH+H₂O Equation 2

6H₂+2CO₂→C₂H₅OH+3H₂O Equation 3

This provides a new heat engine cycle that has a greater energy conversion efficiency limit than a fuel cell utilizes; such a liquid fuel used to supply hydrogen for stratified-charge internal combustion can be brought to a peak combustion temperature of 6,500° F. to 7,000° F. (6,960° R to 7,460° R) by preheating the fuel to about 1,000° F. Equations 4 and 5 compare the Carnot limit of this system with an ambient temperature, hydrogen-oxygen fuel cell as summarized by Equations 6 and 7. In some embodiments, such efficiency improvement achieved by preheating fuel as shown by Equation 5 starts with heating liquid hydrogen carriers such as alcohols or cryogenic hydrogen. For example, cryogenic hydrogen can be heated from −421° F. as it cools air in a turbocharger intercooler, and can then be further heated by counter current heat exchange with exhaust from a compound engine such as a turbocharger, and subsequently by exhaust from a primary engine and/or from regenerative heat produced by vehicle deceleration.

The heat engine efficiency shown in Equations 4 and 5 includes combustion of fuel and expansion through the two compounded engines from 6,960° R to 660° R, and regenerative preheating of the fuel to about 1,000° F. (1,460° R) for improving the overall potential energy conversion efficiency by changing the fuel from liquid to high pressure gas that is injected after top dead center to substantially improve the thermodynamic cycle.

Carnot efficiency limit E=(T_{H}−T_{L})/T_{H} Equation 4

Heat Engine Efficiency limit E=(6960T_{H}−660T_{L})/6960T_{H}=91% Equation 5

The same chemical reaction for hydrogen and oxygen in a fuel cell at ambient temperature is summarized by Equations 6 and 7 for the process of converting −237.2 kJ/mol of available energy (ΔG) from −285.8 (ΔH) total process energy.

H₂+0.5O₂→H₂O+Electric Work Equation 6

Fuel Cell Efficiency E=−237.2 kJΔG/−285.8 kJΔH=83% Equation 7

Pressurization of the hydrogen and oxygen delivered to a fuel cell can improve the operating efficiency, but much greater economic benefits may be provided by improvement of the vast population of existing heat engines. Further improvement in practical engine efficiency toward the Carnot limit of 91% can be achieved by endothermic dissociation and/or reaction of a suitable hydrogen carrier such as ammonia, methanol, ethanol, propanol, or butanol with an oxygen donor in an endothermic reaction to convert the reactants into products with higher combined chemical and pressure potential energy content. Equations 8 and 9 illustrate this general process for numerous alternative partial oxidation endothermic utilizations of heat transferred from engine or fuel cell coolant, engine exhaust gases, and/or heat produced by vehicle deceleration regeneration processes.

CH₃OH+HEAT→2H₂+CO Equation 8

C₂H₅OH+2H₂O+0.5O₂→5H₂+2CO₂ Equation 9

In some embodiments, suitable material selections for accomplishing the electrical and/or thermal barrier functions of the mechanical stroke modifier 650 can include sapphire balls and silicon carbide races for bearings 608, 616, and/or 622; silicon nitride, spinel, or partially stabilized zirconia for pinions, gears, or wheels 602, 604, 606, and/or 620; and similar ceramics or heat resisting stainless steel or super-alloy racks or struts that are displaced in vectors such as 610 and 614. In further embodiments, other materials can be used.

FIG. 7A is a cross-sectional side view of a fuel injector assembly 700 configured in accordance with embodiments of the technology. FIGS. 7B and 7C are magnified views of portions of the injector assembly 700 of FIG. 7A configured in accordance with embodiments of the technology. FIG. 7D is an end view of the injector assembly 700 of FIG. 7A. Referring to FIGS. 7A-7D together, the injector assembly 700 includes several features generally similar to the injector 101 described above with reference to FIG. 1. The injector assembly 700 enables operations such as a thermodynamic cycle of engine operation including Joule-Thomson expansively cooled fluid injection during compression of an oxidant, and/or Joule-Thomson expansively heated fluid at or after top dead center (TDC).

In certain embodiments the fuel injector assembly 700 includes or can be coupled to a thermochemical reactor assembly including an accumulator volume for storage of chemical and/or pressure and/or thermal potential energy. Such an accumulator can be utilized for storing potential energy such as chemical, temperature, and pressure contributions to potential energy. One exemplary accumulator stores hot hydrogen at high pressure, such as at temperatures from about 700° C. to 1500° C. (1300 to 2700° F.). Such hydrogen inventory includes hydrogen that has been separated by galvanic proton impetus to deliver pressurized hydrogen into the accumulator volume around a cathode zone after production of such hydrogen in conjunction with an anode zone from a hydrogen donor formula or mixture that may include substances such as ammonia, urea, a fuel alcohol, formic acid, water, oxygen, or various hydrocarbons such as natural gas or other petroleum products that are delivered by a suitable conduit.

Heat from a suitable source such as the exhaust of an engine may be utilized to preheat hydrogen donor substances in heat exchanger arrangements within a suitably reinforced and insulated case as discussed in U.S. patent application entitled “INJECTOR-IGNITER WITH THERMOCHEMICAL REGENERATION,” Attorney Docket No. 69545-8337.US00, and filed concurrently with the present application, and which is incorporated by reference herein in its entirety. Suitable heat exchange arrangements include systems such as a helical coil surrounding a pressure containment tube or vessel prior to admission of such hydrogen donor fluid into the tubular bore of the accumulator within a tube or pressure vessel. Additional heat may be added by a resistance or inductive heater using electricity from a suitable source such as the regeneratively produced electricity from stopping a vehicle and/or from regenerative shock absorbers and/or suspension springs. Such sources of electricity are also utilized to provide an electrical potential between electrode-anode and another electrode cathode to produce galvanic impetus to separate and deliver hot, pressurized hydrogen into the associated accumulator.

Gases including mixtures not entirely converted to hydrogen such as remnant portions of feedstock fuels, carbon monoxide, carbon dioxide, nitrogen, and/or water vapor etc., can be provided from the accumulator to the injector assembly 700 through a suitably insulated and/or cooled conduit 666. Hot, high pressure hydrogen can be delivered through an insulated conduit 664 to the injector assembly 700.

It can be highly advantageous in certain embodiments to utilize the injector assembly 700 to deliver cooled gases into the combustion chamber of an engine before top dead center (TDC) to perform cooling of the oxidant, such as air, and thus reduce the backwork of compression. This arrangement can provide improved brake mean effective pressure (BMEP) in the operation of the engine. Subsequently, hot hydrogen can be delivered as a high pressure expansion heating substance at or after TDC to increase the BMEP of the engine and improve the combustion characteristics, including acceleration, of the ignition and completion of combustion of fuel delivered through other conduits such as the conduit 666.

The injector assembly 700 can utilize a suitable valve operator such as a pneumatic, hydraulic, electromagnetic, magnetostrictive or piezoelectric assembly 702 to control the opening and/or closing of a fuel control valve 704 which is shown in the magnified views of FIGS. 7B. and 7C. Fuels from the non-hydrogen fluid accumulator may be cooled. In some embodiments, the cooled fuels can achieve temperatures that approach cryogenic methane or hydrogen in instances that a suitable fuel tank is utilized for such storage.

At selected times, such as during the compression cycle of oxidant in the host engine, pressurized fluid from the conduit 666 can be selected by a rapid response valve assembly 780 which can be actuated by a suitably separated and/or insulated pneumatic, hydraulic, electromagnetic, magnetostrictive or piezoelectric actuator 782 to rapidly produce output through a first linkage 788 and mechanically amplified stroke through a second linkage 790 by lever linkage 784 to move a suitable valve, such as a spool valve within a case 792, to deliver expansively cooling fluid during oxidant compression and expansively heating fluid at or after TDC (e.g. hot high pressure hydrogen from the hot accumulator) through the insulated conduit 664. Similarly, rapid repositioning of the shuttle valve by the mechanical amplifier delivers suitably conditioned (e.g., cooled) fluid through the conduit 666 to a conduit within the case 792 for injection controlled by the valve 704 as shown.

The valve assembly 780 is provided at a suitable location as shown for purposes of functionally isolating fluids (e.g. hot, corrosive, or cold fluids) provided to the combustion chamber of an engine as controlled by the operation of the valve 704. At other selected times, another fluid that is delivered through a fitting 734 from a pressure regulator 732 may be used to cool and/or provide deliveries of incipient crack repair agents such as activated monomers and/or precursors for polymeric, glass, ceramic, or composite insulation systems 720 which may include components that also may provide functions such as charge storage (e.g. capacitors).

In operation, the valve 704 is opened and/or closed by the piezoelectric assembly 702. In some embodiments the piezoelectric assembly 702 comprises a piezoelectric stack that produces an output that is mechanically amplified (e.g., using any of the mechanical stroke modifiers described above). Alternately, the piezoelectric stack may be selected with sufficiently long actuation stroke. In both such arrangements, the piezoelectric assembly 702 can be controlled by adaptively adjusted applied voltage to open the valve 704 variable distances to control the rate of fluid flow such as fuel delivery into the combustion chamber of the engine. Instrumentation may be provided and/or relayed to a controller (e.g., a microcontroller) 730 by relay components 712 such as light pipes or fiber optics 712A. The relay components 712 can monitor the opening from the valve seat portion. An electrode component 710 can control the piezoelectric assembly 702 and/or the flow delivered past the valve 704 as shown. Additional instrumentation fibers 712B can monitor and relay combustion chamber information to the controller 730 such as temperature, pressure, injected fluid penetration and patterns including intake, compression, combustion, and exhaust events. Such instrumentation fibers 712B may be routed through spaces available or provided within the mechanical amplifier systems such as described above and may include sheathing to protect against wear or fretting by relative motion components.

Injection and/or ignition of fuel delivered through the valve 702 can be through the annular pathway and/or channels between the pressure regulator 732, which may produce swirl or other shapes of fluid such as fuel projections into the combustion chamber 740. Ignition may be selected from spark, ion thrusting, and/or corona discharge within combustion chamber 740. Illustratively, ion production and acceleration starting with ion current development between relatively small gaps between one or more relay components 712 and a suitably shaped counter electrode 714 provides ion thrusting of adaptively adjusted ion populations by the controller 730 in response to information such as may be relayed through filaments or fibers 712A and/or 712B. Corona discharge may follow such ion launch patterns for further ion production and/or ionizing radiation accelerated initiation and/or completion of combustion operations.

Low voltage electricity may be utilized to operate the injector assembly 700 and may be supplied from suitable circuits within the controller 730 or at other suitable locations including production of high voltage for spark, ion thrusting and/or corona ignition by selected transformer elements and cells of an assembly 722A-722R as shown with abbreviated designations of such inductive windings. High voltage can be delivered through one or more insulated conductors 724 to a conductor tube 726 and thus to the electrode component 710 as shown for such applications.

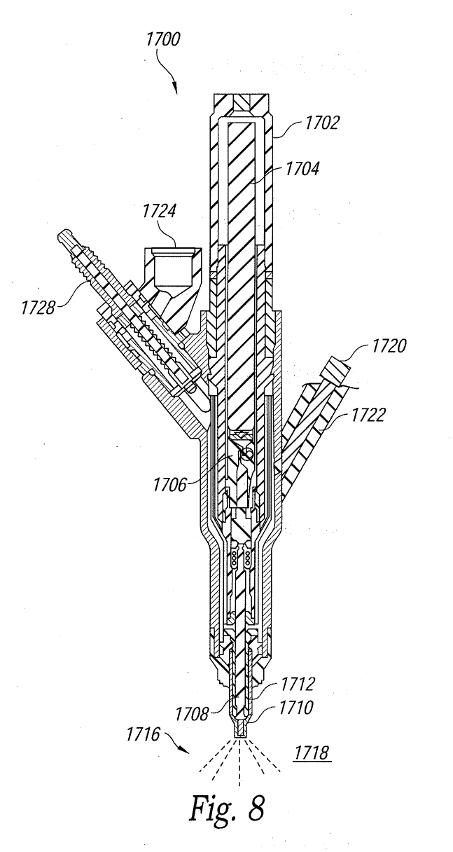

FIG. 8 is a cross-sectional side view of a combined fuel-injection and ignition system 1700 configured in accordance with embodiments of the technology. In some embodiments, the system 1700 can be used to convert existing engines to net operation on hydrogen in a new thermodynamic cycle that achieves much greater efficiency than traditional diesel engines or fuel cells. The system 1700 can further be used in new production engines.

In some embodiments, the system 1700 includes a case 1702 that compressively loads a piezoelectric valve actuator 1704. In some embodiments, the case 1702 is at least partially made of steel, stainless steel, glass, or super alloy. The actuator 1704 is coupled to a mechanical stroke modifier 1706 having several features generally similar to any of the mechanical stroke modifiers described above.

The mechanical stroke modifier 1706 can be employed in the manner described above with reference to FIG. 6 for operation as an electrical and thermal barrier assembly having wheels, pinions, and gears. The amplified motion of the actuator 1704 provides valve opening for control of fuel flow from a port 1720 and/or 1724, through an annular passageway within coaxial extended electrode components 1708, 1710 (i.e., the valve) and into a spray pattern 1716 penetrating a combustion chamber 1718.

Another advantage of the amplifying and electrical and/or thermal insulating capabilities of the system 1700 is that the fuel injector 700 shown in FIG. 7A can utilize the mechanical stroke modifier 1706 to convey force in various directions. Using the mechanical stroke modifier 650 of FIG. 6 as another example, the mechanical stroke modifier 650 can apply force in any direction that is more or less tangential to the rims of the pinion, gear, and wheels 602, 604, 606, and/or 620 including push or pull forces. Referring again to FIG. 8, in some embodiments the operation of the actuator 1704 can produce inward motion through a valve sleeve 1712 to provide an annular passageway past the extended electrode component 1708. In other embodiments, the operation of the actuator 704 can produce outward motion through the extended electrode component 1708 to provide an annular passageway past the valve sleeve 1712.

The electrical insulating and heat blocking capabilities of the mechanical stroke modifier 1706 can allow heated, high pressure fuel gases such as heated hydrogen or hydrogen-characterized mixtures (as illustrated by representative Equations 8 and 9) to be provided through a conduit connected by a fitting 1720 within an insulator 1722. The fuel gases can be delivered through suitable internal passageways to an annular gap between the extended electrode components 1708 and 1710 to produce Lorentz thrusting of oxidant and/or fuel ions in the spray pattern 1716 and/or with subsequent corona ignition in the spray pattern 1716. This embodiment also enables occasional flow of cooler fuel fluids through a fitting 1724 to intermittently cool the internal passageways and remove heat from the actuator 1704 and other components, such as the mechanical stroke modifier 1706. This can maintain high dielectric strength capabilities of an insulator 1728 and other components within the case 1702, and in some instances can include the dielectric fluid admitted through the fitting 1724 as shown.

U.S. patent application entitled “HYDRAULIC DISPLACEMENT AMPLIFIERS FOR FUEL INJECTORS,” Attorney Docket No. 69545-8334.US01, and filed on or before Mar. 15, 2013, and U.S. patent application entitled “SYSTEMS AND METHODS FOR PROVIDING MOTION AMPLIFICATION AND COMPENSATION BY FLUID DISPLACEMENT,” Attorney Docket No. 69545-8336.US01, and filed on or before Mar. 15, 2013, are incorporated by reference herein in their entireties.

From the foregoing it will be appreciated that, although specific embodiments of the technology have been described herein for purposes of illustration, various modifications may be made without deviating from the spirit and scope of the technology. Further, certain aspects of the new technology described in the context of particular embodiments may be combined or eliminated in other embodiments. Moreover, while advantages associated with certain embodiments of the technology have been described in the context of those embodiments, other embodiments may also exhibit such advantages, and not all embodiments need necessarily exhibit such advantages to fall within the scope of the technology. Accordingly, the disclosure and associated technology can encompass other embodiments not expressly shown or described herein. Thus, the disclosure is not limited except as by the appended claims.

I/We claim:

1. A gaseous fuel injector, comprising:
a piezoelectric actuator; and
a mechanical stroke amplifier, including:
an input plunger connected to a surrounding transfer sleeve via a first lever, wherein the first lever is mounted to a first fulcrum disposed between the input plunger and the transfer sleeve; and
an output plunger connected to the transfer sleeve via a second lever mounted to a second fulcrum disposed between the output plunger and the transfer sleeve.

2. The fuel injector according to claim 1 wherein the first lever and second lever extend laterally from the transfer sleeve.

3. The fuel injector according to claim 1 wherein the first lever is pivotably mounted at a pivot location along a length of the first lever to the first fulcrum, wherein the pivot location is closer to the input plunger than the transfer sleeve.

4. The fuel injector according to claim 1 wherein the input plunger and output plunger are nonparallel.

5. The fuel injector according to claim 1 wherein the mechanical stroke amplifier further includes at least one of a spring, magnet, or pneumatic cylinder coupled to at least one of the input plunger or output plunger and configured to return the mechanical stroke amplifier to a starting position at the end of a mechanical stroke amplification cycle.

6. A fuel injector for introducing fuel into a combustion chamber, the injector comprising:
an injector body including—
a base portion configured to receive fuel into the body; and
a valve coupled to the body, wherein the valve is movable to an open position to introduce fuel into the combustion chamber; and
a valve operator assembly, the valve operator assembly including—
a valve actuator coupled to the valve and movable between a first position and a second position;
a prime mover configured to generate an initial motion; and
a mechanical stroke modifier configured to alter at least one of a direction or magnitude of the initial motion and convey the altered motion to the valve actuator.

7. The fuel injector of claim 6 wherein the prime mover comprises at least one of a piezoelectric, magnetostrictive, electromagnetic, electromechanical, pneumatic, or hydraulic force generator.

8. The fuel injector of claim 6 wherein the mechanical stroke modifier comprises a plurality of operably connected gear racks and pinions, wherein a first pinion has a different diameter than a second pinion.

9. The fuel injector of claim 6 wherein the mechanical stroke modifier comprises a lever configured to receive the initial motion via a first strut, increase or decrease the magnitude of the initial motion, and transfer the motion to a second strut.

10. The fuel injector of claim 6 wherein at least a portion of the mechanical stroke modifier comprises a low-friction material or coating.

11. The fuel injector of claim 6 wherein the fuel injector comprises a combined fuel injector and fuel igniter.

12. The fuel injector of claim 6 wherein the mechanical stroke modifier comprises at least one of an electrical or thermal barrier.

13. The fuel injector of claim 12, wherein:
the valve operator assembly further comprises a displacement driver configured to instigate a push, pull, and/or push and pull displacement of the valve actuator, thereby instigating movement of the valve;
the prime mover operates at a first temperature; and
the mechanical stroke modifier is configured to convey the altered motion to the displacement driver at a second temperature higher than the first temperature.

14. A method of operating a fuel injector to inject fuel into a combustion chamber, the method comprising:
introducing fuel into a body portion of the fuel injector, the body portion including a mechanical stroke modifier and a valve adjacent to the combustion chamber, the valve being moveable between an open position and a closed position;
imparting a motion to the mechanical stroke modifier;
modifying a direction or magnitude of the motion;
actuating the valve via the modified motion to move between the closed position and the open position; and
introducing fuel from the body portion into the combustion chamber.

15. The method of claim 14 wherein imparting a motion to the mechanical stroke modifier comprises imparting motion via one or more of a piezoelectric, magnetostrictive, electromagnetic, electromechanical, pneumatic, or hydraulic force generator.

16. The method of claim 14 wherein modifying a direction or magnitude of the motion comprises modifying the motion with a plurality of operably connected racks and pinions.

17. The method of claim 14 wherein modifying a direction or magnitude of the motion comprises modifying the motion with a plurality of operably connected levers and struts.

18. The method of claim 14, further comprising modifying a thermal characteristic of at least a portion of the fuel injector or the fuel.

19. The method of claim 18, further comprising preheating the fuel before introducing the fuel into the combustion chamber.

20. The method of claim 14, further comprising sensing one or more conditions in the combustion chamber, and wherein modifying a direction or magnitude of the motion comprises adaptively altering, in response to the sensing, a motion of the fuel or the valve, or a thermal characteristic of the fuel.
